(19) United States
(12) Patent Application Publication
(10) Pub. No.: US 2007/0178014 A1
(43) Pub. Date: Aug. 2, 2007

(54) Device and method for microcontact printing

(75) Inventors: Robert C. Haushalter, Los Gatos, CA (US); Srinivas Vetcha, Sunnyvale, CA (US)

Correspondence Address: DUANE MORRIS LLP, PO BOX 5203, PRINCETON, NJ, 08543-5203, US

(73) Assignee: PARALLEL SYNTHESIS TECHNOLOGIES, INC., Sants Clara, CA (US)

(21) Appl. No.: 10/582,562

(22) PCT Filed: Dec. 13, 2004
(86) PCT No.: PCT/US04/42016

§ 371 Date: Apr. 13, 2007

Related U.S. Application Data
(60) Provisional application No. 60/528,993, filed on Dec. 12, 2003.

(51) Int. Cl. B01L 3/02

(52) U.S. Cl. 422/100

(57) ABSTRACT

A microcontact printing pin for depositing a liquid on a substrate includes a printing tip at a first end and a reservoir, which holds a supply of a printing fluid, communicating with the printing tip. A fluid delivery channel extends between the reservoir and the printing tip and the channel has a tapered shape decreasing in width from the reservoir to the printing tip. This tapered shape ensures that the delivery of the printing fluid to the printing tip is smooth, accurate and controllable. The printing tip portion may also be thinned so that the printing tip portion is thinner than the portion provided with the reservoir and a stepped portion between the reservoir and the thinned printing tip portion that eliminates prespotting.

### CROSS-REFERENCE TO RELATED APPLICATIONS

This application claims the benefit of U.S. Provisional Application No. 60/528,993 filed Dec. 12, 2003 the contents of which is incorporated herein by reference.

### FIELD OF THE INVENTION

The present invention relates to microcontact printing devices and a method of fabricating the microcontact printing pins used in such devices.

### BACKGROUND

Microcontact printing of microarrays of many types of biological samples is a popular application for microcontact printing technology. In recent years, the use of silicon-based printing pins has allowed the technology to achieve printing of microarrays having finer sample spot size with improved consistency compared to the stainless steel microspotting pins. But, as the use of the microcontact printing in printing microarrays of biological samples, such as DNA microarrays, continue to grow and new applications for the microcontact printing technology emerges, there is a continual need for improved microcontact printing pins and methods for fabricating such pins.

### SUMMARY OF INVENTION

According to an embodiment of the invention, a pin for depositing a liquid on a substrate is disclosed. The pin comprises a printing tip at a first end and a reservoir, which holds a supply of a printing fluid, communicating with the printing tip. A fluid delivery channel extends between the reservoir and the printing tip for delivering the printing liquid from the reservoir to the printing tip. The channel has a tapered shape decreasing in width from the reservoir to the printing tip. This tapered shape ensures that the delivery of the printing fluid to the printing tip is possible and further more, smooth and consistent. The tapered shape of the channel also allows all of the printing fluid held in the reservoir and the channel to be used up. The printing pin may also have a head portion at its second end that is wider than the rest of the printing pin to provide an area where the pins may be grasped for handling purposes and to prevent the pin from falling through a collimator.

According to another embodiment of the invention, a pin for depositing a liquid on a substrate includes a printing tip at a first end and a reservoir, which holds a supply of a printing fluid, communicating with the printing tip. The printing pin has a thinned printing tip portion and an non-thinned remainder portion which includes the reservoir, that is thicker than the thinned portion and a stepped portion between the printing tip and the reservoir formed by the change in the thickness between the thinned printing tip portion and the non-thinned remainder portion. A fluid delivery channel extends from the reservoir to the printing tip for delivering the liquid from the reservoir to the printing tip. The stepped portion may be curved. The curve may be formed in a variety of shapes, such as an ellipse or a semi-circle. The stepped portion also helps eliminate prespotting phenomena by providing wetting force vectors that oppose the gravitational pull on any excess printing fluid on the outer surface of the printing tip and sheeting down towards the printing tip.

According to another embodiment, a microcontact printing pin holder for use in producing a microarray is disclosed. The pin holder comprises a first planar member, a first aperture extending through the planar member for receiving a pin that deposits a predetermined volume of a liquid on a substrate to produce the microarray, and an elastomeric member provided at a distance above the first planar member.

The pin holder may also include a second planar member having a second aperture extending therethrough for receiving a bottom portion of the pin. The second planar member is disposed under the first planar member such that the apertures are in axial alignment with one another. The pins and the pin holder of the invention described herein may be microfabricated from a material selected from the group consisting of semiconductors, polymers, ceramics, and non-ferric alloys.

### BRIEF DESCRIPTION OF THE DRAWINGS

All drawings are schematic and are not to scale. Like reference numerals used in the drawings refer to like structures.

FIGS. 1A-1G illustrate the microfabrication of microcontact printing pins and pin holders according to an exemplary embodiment of the invention.

FIG. 2 is a plan view of a microcontact printing pin of the invention fabricated with the microfabrication process illustrated in FIGS. 1A-1G.

FIGS. 3A-3D illustrate a variety of printing pin thinning processes according to an embodiment of the invention.

FIGS. 3E and 3F illustrate the printing pin layouts in relation to wet etched pits on a silicon wafer stock being processed according to an embodiment of the microfabrication process of the invention.

FIG. 4 is an isometric view of the printing tip end of a microcontact printing pin that has been thinned by a microfabrication process according to an embodiment of the invention.

FIGS. 5A-5I illustrate microfabrication process steps for forming an embodiment of a printing pin having a thinned printing tip according to another embodiment of the invention.

FIGS. 6A-6E illustrate microfabrication process steps for forming another embodiment of a printing pin having a thinned printing tip according to another embodiment of the invention.

FIG. 6F is a plan view of a microcontact printing pin whose printing tip end has been thinned by the microfabrication process illustrated in FIGS. 6A-6D.

FIG. 7A is a perspective view of the printing tip end of a microcontact printing pin according to an embodiment of the invention holding an amount of printing fluid after a fluid pick up.

FIGS. 7B and 7C are side elevational views of the microcontact printing pin of FIG. 7A, printing a print spot on a substrate.

FIG. 7D is a perspective view of another embodiment of the printing tip end of the microcontact printing pin of FIG. 7A.

FIG. 8A is a perspective view of the printing tip end of the microcontact printing pin of FIG. 6E holding an amount of printing fluid after a fluid pick up.

FIGS. 8B-8C are side elevational views of the microcontact printing pin of FIG. 8A, printing a print spot on a substrate.

FIG. 8D is a side elevational view of the microcontact printing pin of FIG. 6E after some of the printing fluid has been depleted.

FIG. 8E is a plot comparing the print spot size profile between a microcontact printing pin of FIG. 7A and the microcontact printing pin of FIG. 8A.

FIG. 9 is a perspective view illustration of a microcontact printing pin according to an embodiment of the invention.

FIGS. 10A-10C are isometric views of a variety of printing tip configurations according to an embodiment of the invention.

FIG. 11A is a plan view of a section of a pin holder according to an exemplary embodiment of the invention.

FIG. 11B is an elevational view of the pin holder.

FIG. 12A is an elevational view of the pin holder according to another embodiment of the invention.

FIG. 12B are elevational views illustrating the operational advantage of the pin holder of FIG. 12A.

FIGS. 13A and 13B are elevational views illustrating the operation of the pin holders of FIGS. 12B-A and 12B-C.

FIGS. 14A and 14B are elevational views of another embodiment of the pin holders of FIGS. 13A and 13B.

### DETAILED DESCRIPTION OF THE INVENTION

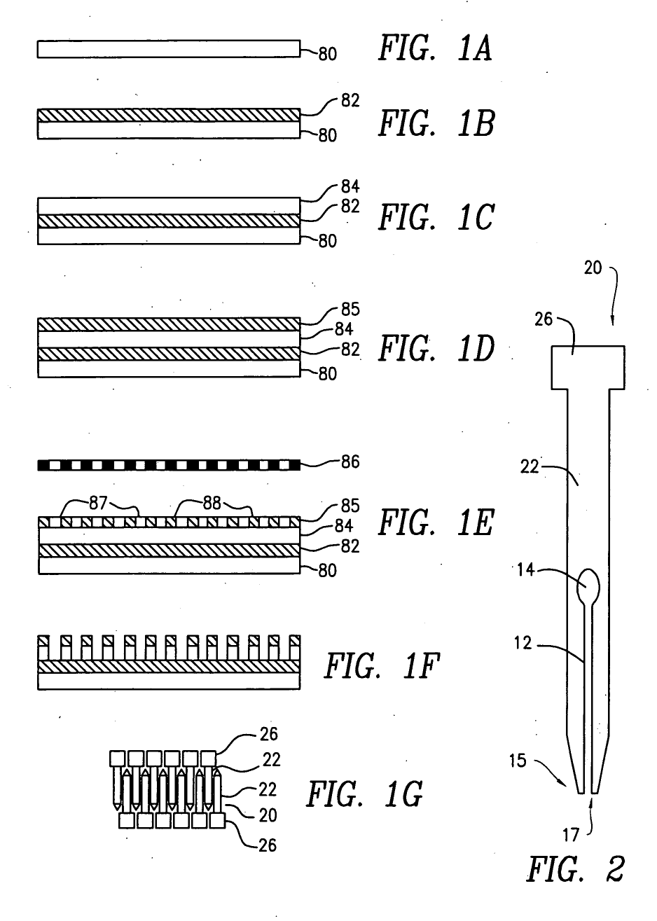

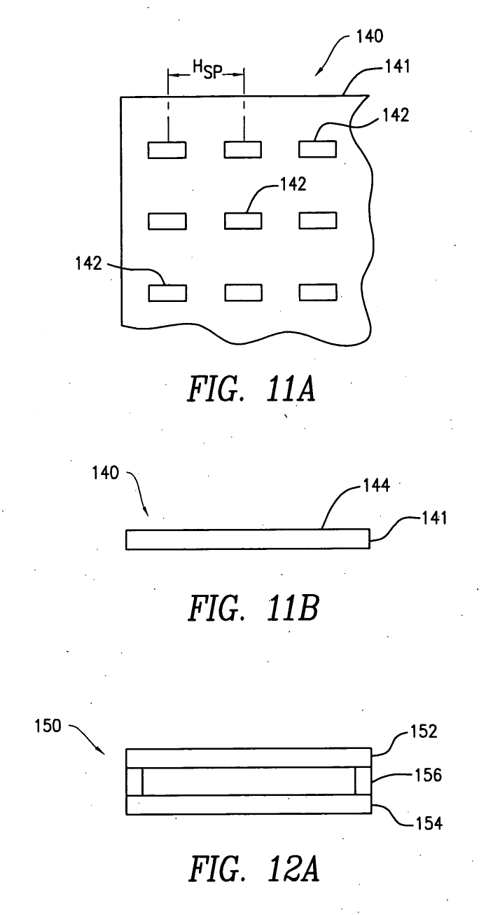

FIGS. 1A-1G illustrate the microfabrication of silicon-based pins 20, having non-thinned printing tip, and pin holders (see the planar member 141 of FIG. 11A) according to an exemplary embodiment of the present invention using conventional silicon microfabrication methods. First, pin and pin holder design data is used to design a photo mask 86 (see FIG. 1E). The design of the photo mask 86 may be prepared using any suitable CAD software program, such as AutoCAD®. The photo mask 86 may then be prepared, for example, by generating a negative image of the design in chromium on a long wavelength UV transparent glass substrate.

As shown in FIGS. 1A and 1B, a first layer of photoresist 82 may be deposited onto a first silicon wafer 80. The first silicon wafer 80 may be made from single crystal silicon having a (100) crystal orientation, with both sides polished and about 200 μm thick. The first layer of photoresist 82 may be deposited, for example, using a conventional spin coating technique.

In FIG. 1C, a second silicon wafer 84 (component wafer 84) is bonded on top of the first silicon wafer 80 (support wafer 80) by placing the second wafer 84 on top of the first layer of photoresist 82 and soft-baking the first layer of photoresist 82 for about 1 and 2 minutes at approximately 90°. The second silicon wafer 80 may also be made from single crystal silicon having a (100) crystal orientation, with both sides polished and about 200 μm thick. The first layer of photoresist 82 between the wafers 80, 84 prevents severe undercutting of the component wafer 84 when etchant travels therethrough. Such an etchant is used when, for example, Reactive Ion Etching (RIE) micromachining is used. One of ordinary skill in the microfabrication art will of course recognize that any other suitable bonding material or method may be used to bond the two wafers 80, 84 together.

As shown in FIG. 1D, a second layer of photoresist 85 is deposited over the component wafer 84 and soft-baked. The second layer of photoresist 85 layer is patterned as shown in FIG. 1E, by placing the photo mask over the second layer of photoresist 85, irradiating the wafers 80, 84 and developing the second layer of photoresist 85. The irradiated portions 87 of the second layer of the photoresist 85 are removed from the component wafer 84, thus, leaving a photoresist pattern thereon, which is made up of the non-irradiated regions of photoresist 88.

In FIG. 1F, the pins and holders are micromachined from the component wafer 84 using any conventional silicon micromachining technique, such as Deep Reactive Ion Etching (DRIE). As is well known in the silicon microfabrication art, the micromachining process removes the portions of the silicon wafer not protected by the photoresist. Dry etching techniques such as plasma etching are used for etching features with variable tapering and high aspect ratio microstructures. The most common forms of dry etching for micromaching or microfabrication applications are isotropic ion etching and anisotropic DRIE. Unlike anisotropic wet etching, DRIE etching is not controlled by the relative etch rates of the silicon crystal planes and, thus, deep channels and pits up to few tens of microns deep with nearly vertical walls and of arbitrary shape can be etched using anisotropic DRIE technique.

The general layout of the pins 20 on a section of the component wafer 84 is shown in FIG. 1G. As can be seen mounting heads 26 of the pins 20 may be packed closely together with the shafts 22 filling most of the space when the pins 20 are formed in an interdigitated pattern. This efficient space filling allows the maximum number of pins to be fabricated per unit area of wafer surface.

The component wafer 84 is machined all the way through as shown in FIG. 1F to separate the pins and pin holders. The separated pin and pin holders are removed from the support wafer 80 by dissolving the first and layer of photoresist 82 with solvent (the solvent also removes the patterned sections 88 of the second layer of photoresist 85 from the components). After several thorough washings in fresh solvent, the separated pins 20 and pin holder components are oxidized using conventional well known silicon oxidizing methods to form a coating of (typically about 0.5 to 1 μm thick) SiO₂ hydrophilic film layer on the components. At this stage, the pins 20 and the pin holder may be assembled.

Referring to FIGS. 1G and 2, the microcontact printing pins 20 comprise shaft 22 having a head portion 26 at one end thereof and a printing end at the opposite end. The printing end comprises a reservoir 14 for holding a supply of printing fluid, a printing tip 15, and a delivery channel 12 in communication with the reservoir 14 and the printing tip 15. The channel 12 delivers the fluid from the reservoir 14 to the printing tip 15. The channel 12 divides the printing tip 15 into two prongs and the ends of each prong are printing end wall surfaces 17. The printing end wall surfaces 17 maybe substantially flat but preferably textured or contoured for optimized printing. This aspect of the invention will be further discussed below.

The smoothness (rms roughness) of the DRIE cut surfaces are typically well below 1 μm and 5 μm features are easy to fabricate. Most of the exposed surface of the pin, which corresponds to the polished surfaces of the wafer covered by photoresist during the DRIE treatment, has a roughness only in the tens of Angstroms. This smoothness abrogates the need for the shaft-polishing step required for the steel, which is necessary for the shaft to slide freely in its holder. Since the holder for the silicon pins is also microfabricated, the high tolerances and smooth surfaces allow for a high precision, but smooth fit during the movement of the pin in the holder during printing. Accordingly, the pins and holders have a very smooth, mirror like finish and slide without restriction. Although the machining accuracy of each pin is important, it is also imperative that the uniformity of all pins manufactured is accordingly as high. Batch-to-batch uniformity is one of the great strengths of silicon microfabrication and typically all the components are essentially identical yielding more uniform microarrays. The fabrication of complex pin shapes and the cutting of intricate features into the pins are simple with this fabrication technique, limited only by the achievable feature size, limitations of the cutting technique and the mechanical strength of the part.

The pins and pin holders may be assembled together by placing a desired number of the pins into each of the pin holders. This may be accomplished with the aid of a vacuum tweezers, which grasps the mounting head of the pin. Each pin is dropped into a desired slot in the pin holder with the aid of a small plastic funnel that guides the pin into the slot.

According to the microfabrication process described above, the microcontact printing pins 20 microfabricated out of silicon wafers retain the thickness of the particular silicon wafer 84 used, typically about 200 μm. To produce sample print spot sizes that are smaller than 200 μm, and particularly print spot sizes of 100 μm or smaller diameter, printing pins having printing tips having dimensions that are substantially smaller than the thickness of the stock silicon wafers is necessary.

In the microfabrication process described in reference to FIGS. 1A-1G according to an embodiment of the invention, because the pins 20 are cut from the wafer 84 using an anisotropic plasma etch (DRIE), which cuts perpendicular trenches to the wafer surface, and the plane of the cut lies in the plane of the wafer 84 during fabrication, one of the printing tip 15 dimensions has to correspond to the wafer thickness. Thus, in order to fabricate printing pins having printing tips that are smaller than 200 μm, thinner silicon wafer stocks are needed. However, it is not practical to make thinner silicon wafers for practical handling reasons. For example, 100 μm thick wafers are very fragile and difficult to handle and, thus, it would not be practically feasible to use 100 μm thick silicon wafers to microfabricate print pins having printing tips of 100 μm width.

One way of resolving this problem is to selectively thin the printing pin's printing tip region to shape the printing tip to any desired dimension smaller than the thickness of the starting silicon wafer. The thinning process according to an embodiment of the invention uses either a combination of wet KOH and DRIE etching, or DRIE etching alone, to sculpt the printing tip to the desired shape and dimension by selective thinning process before the pins are cut from the stock wafer.

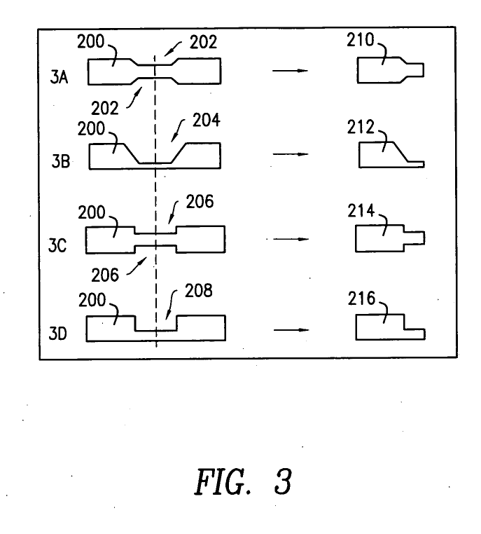

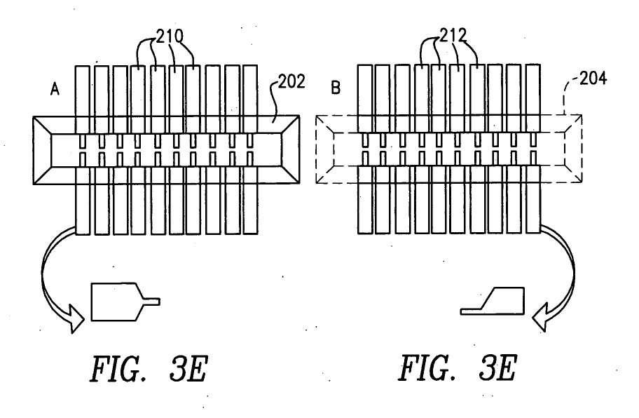

Referring to FIGS. 3A-3D, four basic printing tip shapes may be fabricated depending on whether a wet or DRIE etch is used for the thinning operation which will provide depressions with sloped or vertical sidewalls in a wafer 200, usually a (100) oriented silicon wafer. One example of wet etched design choice is shown in FIGS. 3A and 3B. Unlike DRIE etching, the wet etch process can be run in parallel. By using either a double or single sided etching procedure, the printing pin tip is shaped symmetrically or asymmetrically, respectively, between the two large faces of the starting silicon wafer 200.

FIG. 3A is a sectional view of a silicon wafer 200 in which pits 202 are formed on both faces of the silicon wafer 200 using wet KOH etching process. As shown, because wet KOH etches pits with the bottom of the pit formed from (100) crystallographic plane of the silicon wafer 200 and the sides from (111) crystallographic planes, the pits 202 have sloped sides. FIG. 3B is a sectional view of a silicon wafer 200 in which a pit 204 is formed on one face of the silicon wafer 200 using wet KOH etching process. In the embodiments shown in FIGS. 3C and 3D, the pits 206, 208 are formed with DRIE etching process. Unlike the anisotropic wet KOH etching, DRIE etching is not controlled by the relative etch rates of the silicon crystal planes and, thus, the pits 206 and 208 have vertical sides. In examples illustrated in FIGS. 3A-3D, by cutting the wafer 200 through the broken line of the etched pits 202, 204, 206, and 208 produces two identical printing tips, one of which is shown as 210, 212, 214, and 216 for each of the cuts.

FIGS. 3E and 3F illustrate plan view schematic layout showing the outlines of the printing pins 210 and 212, from FIGS. 3A and 3B, overlaid with the thinning pits 202 and 204. The thinning pit 204 in this view is shown in broken lines to illustrate that it is only on the far side of the silicon wafer 200 being viewed. The printing pins 210 of FIG. 3E are thinned symmetrically from both sides of the wafer 200. The printing pins 212 of FIG. 3F are thinned asymmetrically from one side of the wafer 200.

Next, the outline pattern of the printing pins 210 and 212 is cut by the DRIE etching. For the printing pins 210 which have sloped sidewalls formed by the thinning pits 202 on both sides of the wafer 200, the use of projection lithography is required to pattern the pit surface with the outline of the printing pins 210 before they can be cut by the DRIE etching process. In the case of the printing pins 212, which have the thinning pit 204 only on one side of the wafer 200, the DRIE etching cut may be conducted from the flat side of the wafer 200. Then, the outline pattern of the printing pins 212 may be transferred to the flat surface of the wafer 200 using routine photolithography.

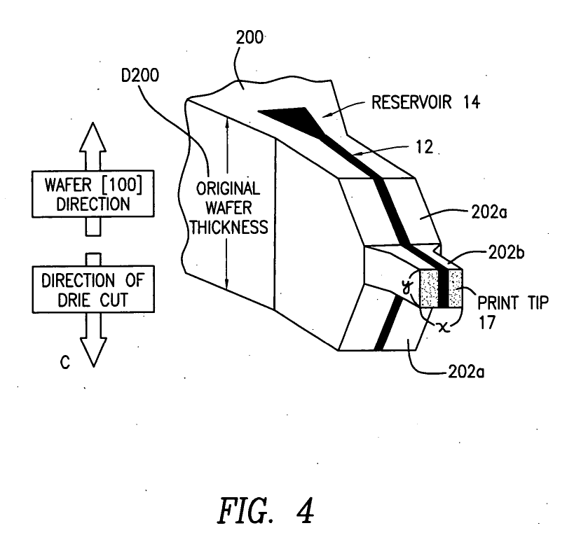

Referring to FIG. 4, one method of reducing the print tip dimensions according to an embodiment of the invention is disclosed. FIG. 4 shows the symmetric printing tip 17 that results when the pins are cut from a substrate that has been thinned on both sides, as shown in FIG. 3E, with a KOH etch. Starting from the original thickness D₂₀₀ of the wafer 200, the wet etched pit 202 forms the sloped surfaces 202a (corresponding to the <111> plane of the silicon wafer) and the horizontal surfaces 202b symmetrically from both large faces of the wafer 200. Next, the wafer 200 is cut by DRIE etching in the direction C, shown in FIG. 4, transverse to the large faces of the <100> orientation silicon wafer 200 to further reduce the print tip 17 to the final dimensions x, y. To reiterate, in this embodiment of the invention, wet KOH etching is used to obtain the y dimension of the printing tip 17. The wet KOH etching thins the <100> orientation silicon wafer 200 in the <100> crystal plane direction creating sloped side walls 202a which are in the <111> crystal plane of the silicon wafer 200. Then, the x dimension of the printing tip 17, and the entire outline of the pin, is obtained by cutting the wafer 200 in the direction C by DRIE etching, the direction C being orthogonal to the <100> crystal plane. The DRIE etching is used to cut through the resulting structure to form the fluid reservoir 14 and the fluid delivery channel 12.

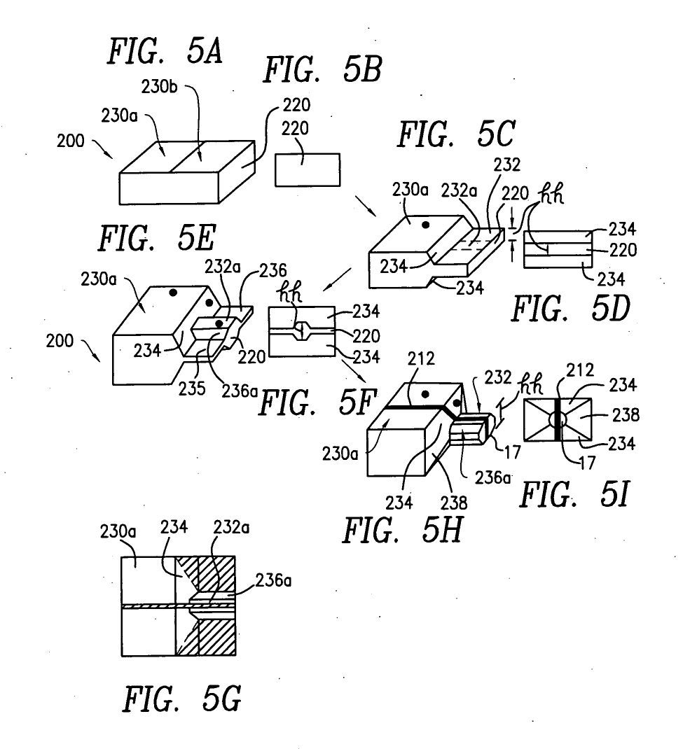

Referring to FIGS. 5A-5H, another embodiment of printing tip thinning process will be described in which the square shaped printing end wall surface 17 of FIG. 4 may be further processed into an octagonal shaped tip. Such an octagonal shape may be more desirable in certain applications because the octagonal shape better approximates a circular printing tip. As shown in FIG. 5A-5D, a <100> oriented silicon wafer 200 is wet etched from both sides of the wafer 200 in a thinning operation to thin a portion of the wafer 200 down to the ultimate horizontal thickness hh of the resulting printing end wall surface 17 (see FIGS. 5G and 5H). To do this, first, the portions of the two faces of the wafer 200 that is not to be thinned, identified as region(s) 230a in FIG. 5A, are protected by forming a coating of etch stop material. The wet etch step usually uses KOH etchant, as discussed above, and for KOH, SiO₂ will suffice as etch stop for typical etch durations involved in this etch depth (less than 100 μm). If more etch stop protection is required, a coating of Si₃N₄ may be used. This is achieved by oxidizing the wafer surfaces by oxidizing in steam at >900° C. to form a dense, thick (0.5-1.0 μm) coating of SiO₂. The SiO₂ coated wafer surface is then patterned by photolithography and selective removal of the SiO₂ coating from the region to be thinned 230b. FIG. 5B shows an elevational view of the side face 220 of the wafer 200 which will eventually form the printing end tip surface 17. Next, the region 230b is thinned by wet KOH etch for an appropriate duration until the side face 220 reaches the thickness hh. FIGS. 5C and 5D show the resulting structure. As discussed above in reference to FIGS. 3A, 3B, and 4, this wet KOH etching produces sloped side walls 234 which are the <111> crystal planes of the silicon wafer 200. The horizontal surface 232 of the thinned portion is the surface parallel to the <100> crystal plane. FIG. 5D shows an elevational view of the side face 220 which is now thinned to the thickness hh. Next, the regions 232a (in the <100> plane) and the sloped side walls 234 are coated with the SiO₂ etch stop layer using photolithography process as described above. The surfaces marked 232a will eventually form two of the eight sides of the octagonal shaped printing end wall surface 17. Next, another wet KOH etching step is carried out, further thinning the portions of surface 232 which are not protected by the etch stop layer (the region 232a). FIGS. 5E and 5F illustrate the resulting structure. The etch stop protected regions 230a, 234, and 232a remain as before but the unprotected regions of the surface 232 has been further thinned down to surface 236. The portion of the side face 220 between the protected surfaces 232a now show six of the eight sides necessary to form an octagon. The region between the protected surfaces 232a has retained the thickness hh. Next, the structure of FIG. 5E is again patterned with an etch stop layer through photolithography to make the final etching step to form the octagonal printing end wall surface 17. As in the previous embodiment, the final etch step is conducted by DRIE etching process. The etch stop layer pattern is as shown in the plan view of FIG. 5G. The non-shaded surfaces are protected by etch stop and the shaded areas are to be cut away by DRIE etching. As noted in FIG. 5G, the pattern for the fluid delivery channel 212 (FIG. 5H) may be created at this time so that the final shaping of the printing end wall surface 17 and the channel 212 can be formed with one DRIE etching step. The etch stop material may be SiO₂ or a photoresist. The resulting octagonal shaped printing end wall surface 17 can be seen in the printing pin tip structure shown in FIGS. 5H and 5I. The DRIE etching has cutaway the shaded areas in FIG. 5G forming the vertical surfaces 238 creating the octagonal shaped printing tip. The fluid delivery channel 212 is also formed.

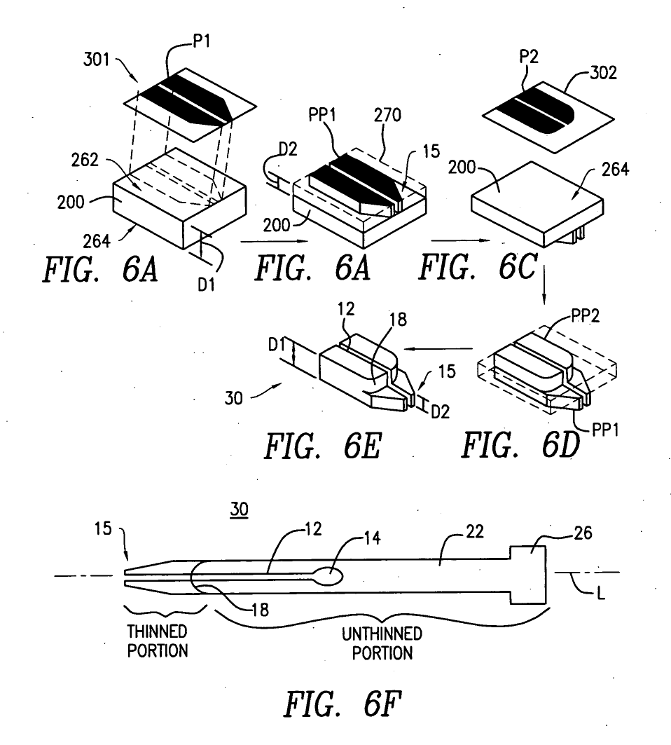

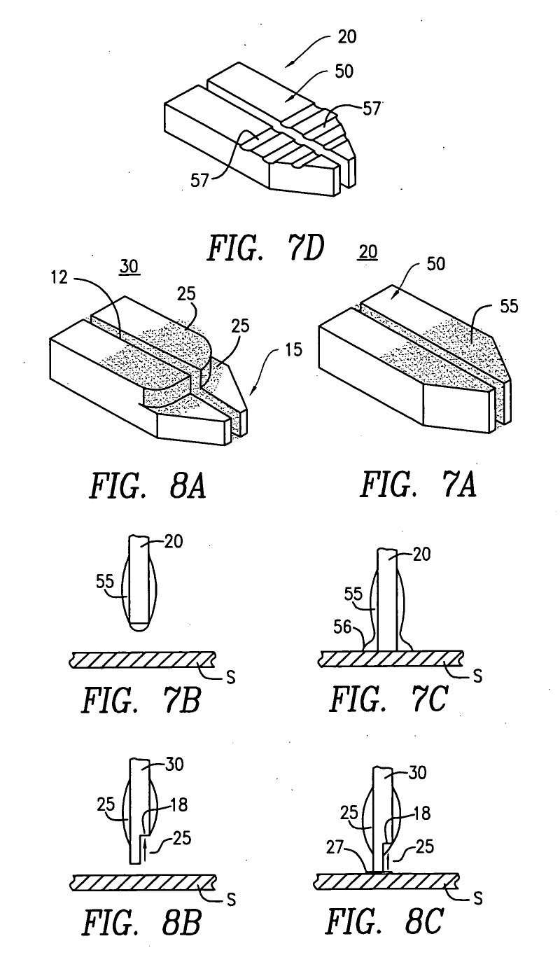

Referring to FIGS. 6A-6E, another method of thinning the printing pin tip according to an embodiment of the invention is disclosed. This method relies on the use of DRIE for all of the etching steps. As shown in FIG. 6A, the <100> orientated silicon wafer 200 is patterned with tips mask 301 with a pin pattern P1 on the first side 262. The pin pattern P1 includes the entire outline of the printing pin, the fluid delivery channel and reservoir (not shown). Next, the first side 262 of the wafer 200 is etched by DRIE etching until a desired thickness D2 is removed. The thickness D2, for example, may be about 100 μm. FIG. 6B shows the removed silicon wafer 200 material in broken lines. The structure PP1 left behind is half of the printing. The wafer 200 is then flipped upside down (FIG. 6C) and the second side 264 of the wafer 200 is patterned with a thinning pattern P2 using a second tips mask 302. The thinning pattern P2 includes the outline of the portion of printing pin tip that is to be removed. The wafer 200 is then DRIE etched second time from the second side 264 of the wafer 200 to remove all of the remaining wafer 200, represented by the broken lines in FIG. 6D, leaving behind the structures PP2 and PP1 which form one contiguous part, the printing pin 30. The thickness of the thinned printing tip 15 is D2, defined by the structure PP1. The unthinned portion of the printing pin 30 retains the thickness D1 of the silicon wafer 200. Because of this change in thickness between the thinned printing tip 15 and the unthinned remainder portion of the printing pin 30, a stepped portion 18 is created. As shown in FIG. 6E, the stepped portion 18 comprises a surface that is substantially orthogonal to the longitudinal axis L (FIG. 6F) of the pin 30. FIG. 6F is a plan view illustration of the printing pin 30 showing its fall outline. The printing pin 30 comprises an elongated shaft 22, a head portion 26 at one end and the printing end at the opposite end of the shaft 22. The printing end includes the thinned printing tip 15, a fluid reservoir 14 provided apart from the printing tip 15 for holding a supply of printing fluid. The printing end also includes a fluid delivery channel 12 extending between the reservoir 14 and the printing tip 15. The stepped portion 18 is provided between the printing tip and the reservoir 14. As will be further described below, the stepped portion 18 serves to eliminate an undesirable prespotting phenomena.

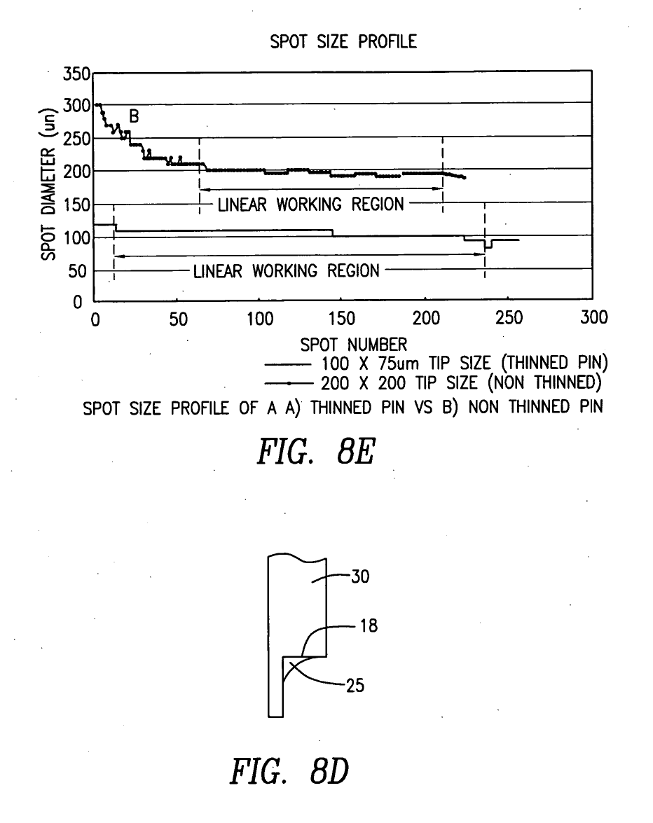

Referring to FIG. 6F, microcontact printing pin 30 is a printing pin microfabricated by the all-DRIE process of the invention described above. The stepped portion 18 between the reservoir 14 and the printing tip 15 formed by the difference in the thickness between the thinned and unthinned portions of the printing pin 30 provides another benefit of directing any printing fluid on the outer surface of the pin into the dispensing channel 12 and to the printing tip 15, thus, eliminating prespotting phenomenon with certain printing tips. As illustrated in FIG. 7A, in a microcontact printing pin 20 that does not have a thinned printing tip and, thus, does not have a stepped portion, when the microcontact printing pin 20 is dipped in the printing fluid for fluid pickup, some excess fluid 55 wets and adheres to the outer walls 50 of the pin 20. FIG. 7B is a side elevational view of the microcontact printing pin 20 after a printing fluid pickup having some printing fluid 55 adhering to the outer surface 50 of the pin 20 and positioned over a substrate S. As shown in FIG. 7C, when the printing pin 20 touches down on the substrate S, the fluid 55 that was adhering to the outer surface 50 of the printing pin 20 wets to the substrate S and dispenses additional amount of the printing fluid 56 on to the substrate S, resulting in a print spot that is larger than intended. This phenomena is referred to herein as prespotting. For a solution like water or aqueous solutions of DNA or proteins in contact with a wettable surface, like the SiO₂ surface of the pin, there is an attractive force perpendicular to the surface holding the liquid to the surface which can be represented as a vector pointing perpendicular to the surface. In certain pin tip shapes such as those shown in FIGS. 8B and 8C, because the surface of the stepped portion 18 is substantially orthogonal to the longitudinal axis L (FIG. 6F) of the pin 30, the wetting force vector V is 180° away from the direction of the print fluid sheeting down the external pin shaft surface toward the substrate and therefore prevents said fluid on the external shaft from reaching the substrate thereby preventing the prespotting phenomena. Thus, the surface of the stepped portion 18 being orthogonal to the longitudinal axis L (which is vertical and parallel to the direction of the gravitational pull while the printing pins 30 are in operation) provides the optimal orientation for the wetting force vector V, i.e., directly opposing the gravitational pull on the print fluid sheeting down the external pin shaft surface. The prespotting phenomena leads to highly variable and oversized spots thereby introducing difficulties into the intensity analysis, increasing the difficulties in spot to spot comparisons and decreasing confidence in results in general.

The microcontact printing pin 30 of FIG. 6F having the stepped portion 18 after it has picked up some printing fluid (FIG. 8A). Because of the surface reasons given above, the excess fluid 25 wetting the outer surface of the pin 30 tends to collect near the stepped portion 18 away from the printing tip 15. As illustrated in FIGS. 8B and 8C, when the printing pin 30 touches down on the substrate S, only the intended amount of the printing fluid is dispensed from the dispensing channel 12 at the printing tip 15 forming the print spot 27. The excess fluid 25 is held away from the printing tip 15 and the substrate S by wetting to the stepped portion 18. As the printing fluid depletes through further printing, the excess fluid 25 is drawn into the dispensing channel 12 and retracts further away from the printing tip 15 as illustrated in FIG. 8D. The consistency and repeatability of the print spot sizes produced by the thinned printing tips on printing pins of the invention is graphically illustrated in FIG. 8E. FIG. 8E shows the spot profile from the first to the last spot printed from a single sample uptake using the thinned printing pin 30 having the stepped portion 18, as shown in FIGS. 6F and 8A, and the printing pin 20 type shown in FIG. 7A which does not have the stepped portion. The thinned printing pin 30 is able to produce much more consistent print spot sizes.

According to another embodiment, the non-thinned printing pin 20 of FIG. 7A may be modified with grooves 57 on the external walls 50 to produce the same effect of preventing prespotting phenomena as the stepped portion 18 of the printing pins 30.

Referring to FIGS. 6E and 6F, it should be noted that the stepped portion 18 is not a straight ledge but is curved. The curved shape of the stepped portion 18 assists in distributing the stress of the thinned discontinuous structure more widely than a linear cut would. In this exemplary example, the curve approximates a section of an ellipse, however, a variety of other curve shapes, a semi-circle for example, would work.

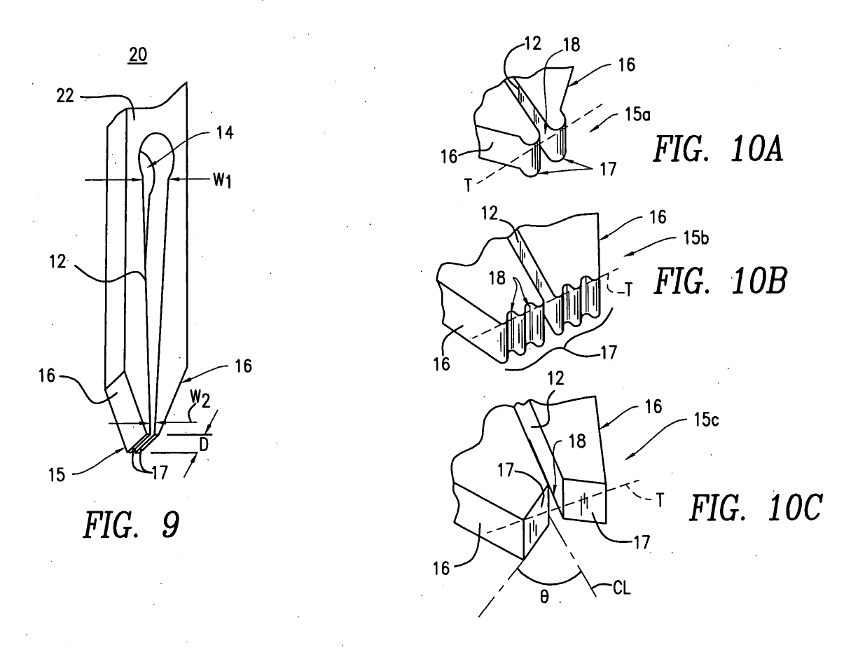

Referring to FIGS. 2 and 9, the printing end of a microcontact pin 20 according to an aspect of the invention is disclosed. The printing end of the printing pin 20 has a printing tip 15 and a reservoir 14 for holding a supply of printing fluid provided apart from the printing tip 15. The structures of the printing tip 15 including but not limited to the reservoir 14 and the channel 12 are configured and dimensioned to optimize the microcontact printing process. The printing tip 15 end of the printing pin 20 is formed with two side wall surfaces 16 that gradually taper toward the printing tip 15. The printing tip 15 is separated into two substantially flat printing end wall surfaces 17 oriented generally perpendicular to the center line CL of the printing pin 20, such that the surfaces 17 are generally parallel to the surface of a substrate to be printed.

The reservoir 14 and the printing tip 15 are connected by an elongated dispensing channel 12 to enable delivery of the printing fluid from the reservoir 14 to the printing tip 15. The dispensing channel 12 has a larger width W1 at the reservoir end and a smaller width W2 at the printing tip 15. The width of the dispensing channel 12 changes gradually and constantly between the reservoir 14 and the printing tip 15 without any abrupt changes. In other words, the dispensing channel 12 has a tapered shape. This tapered shape of the dispensing channel 12, in addition to enabling smooth, accurate and controllable delivery of the printing fluid from the reservoir 14 to the printing tip 15, also very importantly serves to ensure that 100% of the sample taken up into the reservoir 14 and the channel 12 can be delivered to the printing tip 15. When the channel 12 tapers toward the printing tip 15, the meniscus at the top of the reservoir shaft retreats toward the print tip 15 as the reservoir fluid is depleted delivering all of the sample to the printing tip 15. The width W2 of the dispensing channel 12 at the printing tip 15 may be from about 10 nm to several hundred micrometers depending on the thickness of the printing tip 15. The length of the channel 12 can be from several nanometers to several centimeters in length with a preferred length of 1 μm to 50 mm. The degree of taper (defined here as channel width W2 at exit printing tip 15 divided by the width W1 at top of reservoir) over this length can range from about one to about zero with a preferred range between one and 1/10.

Generally, in a conventional printing pin whose dispensing channel has a constant width from the reservoir to the printing tip, as the printing fluid depletes through multiple printing steps and the overall volume of the printing fluid held in the dispensing channel and the reservoir decreases, a meniscus will form in the dispensing channel at the printing tip and the printing fluid will be drawn back up the dispensing channel away from the printing tip. Because the printing tip is not sufficiently wet with the dispensing fluid, dispensing will be inconsistent from one printing spot to the next and the dispensing fluid may not even dispense.

Generally, the printing fluids used with the printing pins of the invention, such as the printing pin 20 are aqueous fluid. And for aqueous printing fluid, the tapered shape of the dispensing channel 12 provides another beneficial function. Because the dispensing channel 12 narrows towards the printing tip 15, and a narrow channel will withdraw liquid from a larger channel of the same depth as the fluid is depleted, the printing tip 15 remains wet even as the printing fluid is depleted from the reservoir and channel. This provides a constant and smooth delivery of the dispensing fluid to the printing tip 15 and utilizes essentially 100% of the sample taken up. The constant and smooth delivery of the dispensing fluid, in turn, helps maintain a consistent print spot size from one print spot to the next and preferably through a series of print spots until the printing fluid held in the reservoir 14 and the dispensing channel 12 is consumed. This beneficial effect of the tapered dispensing channel 12 occurs in this embodiment because the dispensing fluid is an aqueous fluid having polar molecules which wets well to the printing pin surface 15 made from silicon dioxide. Aqueous fluid wets well to the silicon-based printing pin 15 because silicon material has a thin coating of native oxide which naturally forms from exposure to the atmosphere. A more conformal, more durable and thicker coating is made from treating the silicon with steam at 900° C. in air. Aqueous fluid wets well to the native oxide surface because the native oxide, which is SiO₂ is also a polar material.

According to another embodiment, because the native oxide on the silicon surface may not be consistent or thick enough, the native oxide layer may be enhanced by forming a thick, dense, and continuous SiO₂ layer. The thick SiO₂, about 0.5 to 1.0 μm thick, may be formed by treating the silicon-based printing pin with steam at 900-1000° C. The thick continuous SiO₂ coating protects the printing pins 15 from certain chemicals and provides a surface that is easily cleaned and regenerated by heating in the atmosphere or under oxygen. These heating treatments are particularly effective at removing any biological or organic impurities.

Another advantage of the thick SiO₂ coatings on the silicon microcontact printing pins is that from a surface chemistry viewpoint, the SiO₂ surface is identical to glass and thus water or aqueous sample solutions will wet very well to the surface which is necessary for the proper functioning of the printing pins of the invention. Also, by attaching certain chemicals to the surface of the SiO₂, the surface properties of the printing pins may be modified to alter the wetting properties or biological species (e.g. proteins, antibodies, or DNA) can be attached to the SiO₂ surface to greatly increase the molecular specificity. For example, various silanes, such as, trimethylchlorosilane may be added to the SiO₂ surface to make a portion of the surface hydrophobic if necessary.

Referring to FIG. 9, another aspect is the depth of the dispensing channel D, which may be 200 μm (the thickness of the stock silicon wafer used to microfabricate the printing pin), but could also range from 10 nm to several millimeters. The depth D greater than 200 μm can be achieved by using wafers thicker than 200 μm.

Referring to FIGS. 10A-10C, various other configurations for the printing tip 15 of a microcontact printing pin 20 according to another embodiment are disclosed. While some of the current microcontact printing pin's printing tips are flat, i.e. substantially parallel to the substrate on which the printing is conducted, the quality of the printing spots can be improved in terms of consistency of the spot size can be improved if the printing tip 15 is fabricated to have non-flat printing end wall surfaces 17. FIG. 10A illustrates a printing tip 15a where the printing end wall surfaces 17 have curved surfaces. FIG. 10B illustrates a printing tip 15b where the printing end wall surfaces 17 have scalloped surfaces. FIG. 10C illustrates a printing tip 15c where the printing end wall surfaces 17 have sloped surfaces. These examples of non-flat printing end wall surfaces 17 slightly increase the volume of the printing fluid, also referred to as the touch off volume, held at the printing tip by increasing the surface area of the printing end wall surfaces 17 to which the printing fluid wets. The non-flat surface also creates cavity like space(s) at the printing tip 15 which also increases the volume of the printing fluid being held at the printing tip. In the exemplary printing tips 15a, 15b, and 15b illustrated in FIGS. 10A-10C, respectively, cavity or cavity-like space(s) 18 defined between the non-flat printing end wall surface 17 and the tangent line T represent the slight increase in the touch off volume. The tangent line T represents the substrate surface on to which the printing tips 15a, 15b, 15c would print to. In the embodiment of FIG. 10C, the cavity 18 is defined by sloped faces 17 of the printing tip 15c that are oriented at an acute angle θ relative to the center line CL of the pin. Increasing the volume of the printing fluid at the printing tip provide a slightly larger touch off volume which improves the shape and volume of the resultant print spot. The larger tip volume may also allow the same amount of printing fluid to be printed with a lighter than normal touch-off pressure.

The configuration and dimensions of the printing tips on the various embodiments of the printing pins discussed herein according to the invention can be adjusted so that the volume of printing liquid sample deposited by each printing pin and/or the area of the spotted liquid sample (spot) can be varied as desired. It is contemplated that, for example, the configuration and dimensions of the printing tips on the printing pins discussed herein can be adjusted so that the volume of liquid sample deposited by each pin can be as large as about 0.1 milliliters (mL), and as minute as about 10-4 picoliter (pL), or any volume between about 0.1 mL and 10-4 pL. Similarly, the configuration and dimensions of the printing tips can be adjusted so that the area of the liquid sample spots deposited by each pin can be as large as about 10 square millimeters (mm²), and as minute as about 10⁻⁶ square microns (μm²), or any area between about 10 mm² and about 10⁻⁶ μm². There are trade-offs among these dimensions that must be balanced. For instance, increasing the dimensions of the major and minor axes of the reservoir to increase the volume thereof in order to decrease the number of fill steps can compromise the mechanical stability of the printing pin's shaft.

FIGS. 11A and 11B illustrate an exemplary embodiment of the pin holder 140 of the invention. The pin holder 140 is typically configured as a planar member 141 having an array of rectangular, microfabricated slots 142 extending therethrough, each of the slots 142 accepting a microcontact printing pins 120 of the invention. Printing pins 120 may be any one of the embodiments of the printing pins illustrated by the printing pin 30 of FIG. 6E or the printing pin 20 of FIG. 9. The configuration and dimensions of the pin holder 140 may be varied to accommodate up to 100,000 microcontact printing pins 120 of the invention. In one illustrative embodiment, the pin holder 140 may be 10 cm by 16 cm. The configuration and dimensions of the slots 142 may also be adjusted to provide a pin density, i.e., the number of pins per unit area of the holder, of about 1 pin per 10 mm² of holder area to about 10⁶ pins per mm² of holder area. The pin density of the pin holder 140 is important as it determines the spot density of the microarray of samples, such as DNA samples, printed by the assembly of the pin holder 140 and printing pins 120. The slots 142 of the pin holder 140 are also configured and dimensioned to allow the shafts 22 of the pins 120 to be slip-fitted into the slots 142 in a frictionless manner with no lateral movement, and suspended by their mounting heads 26, which rest on the upper surface 144 of the pin holder 140, while preventing rotation of the pins 120 in the slots 142.

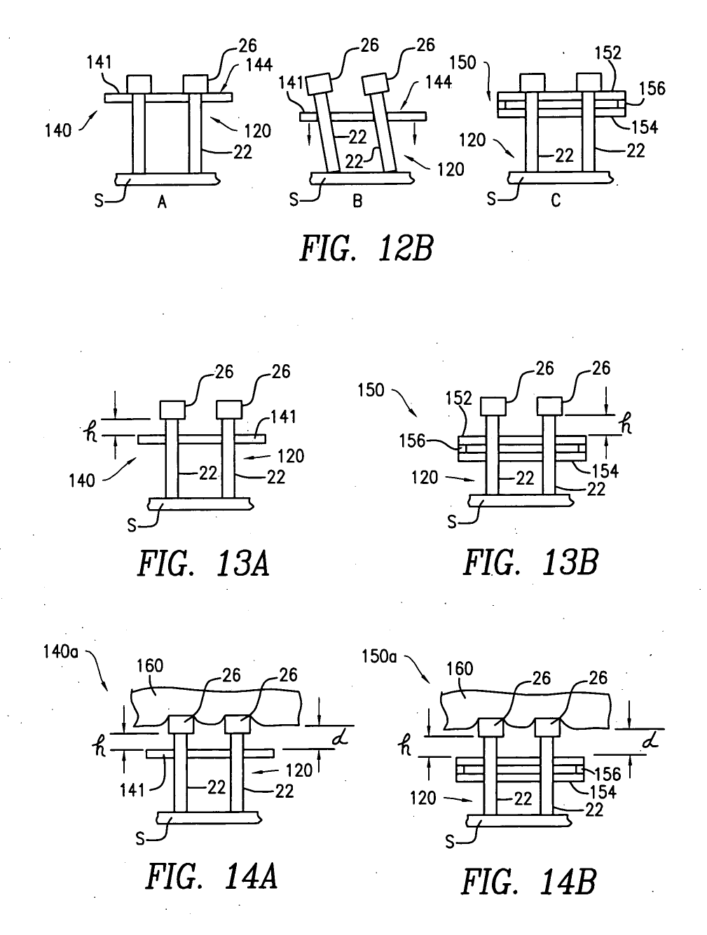

FIG. 12A illustrates a second exemplary embodiment of a pin holder 150 of the invention. In this embodiment, upper and lower planar members 152, 154, respectively, are bonded together by a perimeter spacer 156 in a single unit referred to herein as a collimating holder 150. Each of the upper and lower planar members 152 and 154 are structured substantially same as the planar member 141. The collimating holder 150 is used to prevent the microcontact pins 120 from “tipping over” when touching the substrate S as shown in FIG. 12B. More specifically, when the pins 120 touch the substrate S during printing, the pins 120 may be excessively raised out of the “non-collimated” holder 140 of the previous embodiment such that the head portions 26 of the printing pins 120 no longer touch the upper surface 144 of the planar member 141 to prevent the pins 120 from tipping over. The collimating holder 150 solves this problem by providing the lower planar member 154, which guides the bottom portion of the pin shafts 22 to maintain the vertical orientation of the pins 120 in the collimating holder 150. The pin holder may be microfabricated from a material selected from the group consisting of semiconductors, polymers, ceramics, and non-ferric alloys.

In the exemplary embodiment of FIG. 11A, 1536 slots 142 may be provided in the planar member 141 of the pin holder 140 (or in the upper and lower planar members 152, 154 of the collimating holder 150 of FIG. 12A) and the slots 142 may have a center-to-center spacing Hsp of 2.25 mm. One of ordinary skill in the art will recognize that this embodiment of the pin holder may be advantageously used with a conventional 1536 well microtiter plate (which holds the sample solutions and is not shown herein), as the wells of the microtiter plate have the same 2.25 mm center-to-center spacing as the slots of this exemplary pin holder. Hence, 1536 pins can be installed in the pin holder and dipped directly into all 1536 wells of the microtiter plate, or, with every other pin removed, into a conventional 384 well microtiter plate (which has a 4.5 mm center-to-center well spacing).

Similar to a fountain pen, the microcontact printing pins 120 produces print spots optimally when the printing pins 120 contact the substrate with a certain amount of contact pressure. The specific contact pressure would depend on the particular dimensions of the printing pins 120, the type of printing fluid involved and the type and surface characteristics of the substrate. In the pin holder 140 and the collimating holder 150 described above, the contact pressure exerted by the printing pins 120 on the substrate S is generated by the weight of the printing pins 120 themselves. These are generally referred to as floating pins. As illustrate in FIGS. 13A and 13B, during the microarray printing process, the pin holders 140 and 150 are lowered towards the substrate S until the top surfaces of the planar members 141 and the 152 of the pin holders 140, 150, respectively are distance h (hereinafter, “drop distance”) apart from the head portions 26 of the pins 120. Thus, the weight of the pins 120 is born by the substrate S and not by the pin holders 140 and 150. In these embodiments, the contact pressure of the printing pins 120 are controlled by changing the weight of the printing pins 120.

Referring to FIGS. 14A and 14B, pin holders 140a and 150a according to another embodiment of the invention are illustrated. The pin holders 140a and 150a are provided a means to vary the contact pressure of the printing pins 120 without changing the weight of the printing pins 120. The pin holders 140a and 150a are provided with elastomeric member 160 to exert contact pressure for printing. The elastomeric member 160 may be a sheet-like membrane or a layer of foam positioned above the pins 20 and at a fixed distance d from the top surface of the planar members 141 and 152. After the pins 20 make contact with the substrate S, the pin holders 140 and 150 are lowered further by the drop distance h. But because the elastomeric member 160 is in a fixed relation with the planar members 141 and 152 of the pin holders 140 and 150, respectively, the elastomeric member 160 is lowered at the same time and presses against the head portions 26 of the printing pins 120. By varying the distance d between the elastomeric member 160 and the planar members 141 and 152 and also the drop distance. h, the contact pressure of the pins 120 exerted against the substrate S can be varied. For example, for a given configuration, where the distance d between the elastomeric member 160 and the planar members 141 and 152 are fixed, the contact pressure can be increased by increasing the drop distance h because the head portions 26 of the printing pins 120 will compress further into the elastomeric member 160 causing the elastomeric member 160 to exert greater down force against the printing pins 120. By judiciously selecting material and the physical parameters of the elastomeric member 160, a wide range of contact pressures may be obtained. For example, in an embodiment where the elastomeric member 160 is a polymer foam, its overall thickness, foam cell size, cell density in the foam, the polymer material, and the foam backing, etc. may be varied. In an embodiment where the elastomeric member 160 is an elastomeric membrane, its overall thickness and elasticity of the membrane are some examples of the parameters that may be varied. Regardless of the particular elastomer used, it should not be compliant so that the printing pins recover immediately to its fully extended position in the pin holder when lifted off the substrate so that the pins are ready for the next printing cycle.

The microcontact printing pins described herein are especially useful for printing and manufacturing high quality microarrays of proteins, DNA, RNA, polypeptides, oligonucleotides and microarrays of other biological materials having spot volumes in the range of 10⁻¹⁰ picoliters to 100 nanoliters. The microcontact printhead device may also be used for printing and manufacturing high quality microarrays of other matters including, without limitation, solid semiconductor quantum dots or liquid dots containing various functional molecules, such as sensors, organic small molecules, organic polymers, solutions of organic polymers, dyes, inks, adhesives, molten metals, solders, glasses, and ceramic oxides.

While the foregoing invention has been described with reference to the above, various modifications and changes can be made without departing from the spirit of the invention. Accordingly, all such modifications and changes are considered to be within the scope of the appended claims.

What is claimed is:

1. A pin for depositing a liquid on a substrate, the pin comprising:
a printing tip at a first end thereof;
a reservoir communicating with the printing tip; and a channel extending between the reservoir to the printing tip for delivering the liquid from the reservoir to the printing tip, wherein the channel has a tapered shape decreasing in width from the reservoir to the printing tip.

2. The pin according to claim 1, wherein the pin is microfabricated from a material selected from the group comprising semiconductors, polymers, ceramics, and non-ferric alloys.

3. The pin according to claim 1, wherein the pin has a constant width along a substantial portion of the pin's length and further comprising a head portion disposed at a second end thereof that is wider than the substantial portion of the pin's length.

4. The pin according to claim 1, wherein the printing tip has a non-flat substrate contacting surface.

5. The pin according to claim 1, wherein the pin has a conformal continuous coating of SiO₂.

6. The pin according to claim 1, wherein the reservoir and printing tip are dimensioned to enable the pin to deposit a predetermined volume of the liquid on a substrate when the pin contacts the substrate.

7. The pin according to claim 6, wherein the predetermined volume comprises between about 10⁻⁴ pL to about 0.1 mL.

8. The pin according to claim 6, wherein the predetermined volume of the liquid deposited on the substrate forms a spot having an area of about 10⁻⁶ μm² to about 10 mm² .

9. The pin according to claim 1, wherein the pin has an external wall and grooves provided on the external wall leading to the channel for directing any excess liquid wetting to the external wall to the channels.

10. A pin for depositing a liquid on a substrate, the pin comprising:
a printing tip at a first end thereof;
a reservoir communicating with the printing tip, the pin having a thinned printing tip portion and a non-thinned remainder portion, including the reservoir, that is thicker than the thinned printing tip portion;
a stepped portion between the thinned printing tip and the reservoir formed by the change in the thickness between the thinned printing tip and the non-thinned remainer portion; and
a channel extending between the reservoir to the printing tip for delivering the liquid from the reservoir to the printing tip.

11. The pin according to claim 10, wherein the step has a curved outline.

12. The pin according to claim 11, wherein the curved outline approximates a section of an ellipse.

13. The pin according to claim 11, wherein the curved outline is a semi-circle.

14. The pin according to claim 10, wherein the channel has a tapered shape decreasing in width from the reservoir to the printing tip.

15. The pin according to claim 10, wherein the reservoir and printing tip are dimensioned to enable the pin to deposit a predetermined volume of the liquid on a substrate when the pin contacts the substrate.

16. The pin according to claim 15, wherein the predetermined volume comprises between about 10⁻⁴ pL to about 0.1 mL.

17. The pin according to claim 16, wherein the predetermined volume of the liquid deposited on the substrate forms a spot having an area of about 10⁻⁶ μm² to about 10 mm².

18. A microcontact printing pin holder for use in producing a microarray, the holder comprising:
a first planar member;
a first aperture extending through the planar member for receiving a pin that deposits a predetermined volume of a liquid on a substrate to produce the microarray; and
an elastomeric member provided at a distance above the first planar member,
wherein the holder is microfabricated from a material selected from the group consisting of semiconductors, polymers, ceramics, and non-ferric alloys.

19. The holder according to claim 18, further comprising a second planar member having a second aperture extending therethrough for receiving a bottom portion of the pin, the second planar member disposed under the first planar member such that the apertures are in axial alignment with one another.

20. The holder according to claim 18, wherein the aperture in the first planar member comprises an array of apertures of about 32 apertures to up to about 100,000 apertures.

21. The holder according to claim 18, wherein the aperture in the first planar member comprises an array of apertures having an aperture density of about 1 aperture per 10 mm² to about 10⁶ apertures per mm², the aperture density providing a maximum pin density of about 1 pin per 10 mm² to about 10⁶ pins per mm².

22. A method of making a pin for depositing a liquid on a substrate, the method comprising:
patterning an outline of a bottom portion of the pin on a first side of a silicon wafer by deep reactive ion etch, the outline including a printing tip of the pin;
thinning the printing tip of the pin from the second side of the silicon wafer by deep reactive ion etch.
